(19) United States
(12) Patent Application Publication
(10) Pub. No.: US 2009/0116849 A1
(43) Pub. Date: May 7, 2009

(54) DQPSK modulation apparatus and DQPSK modulation method

(75) Inventor: Noriaki Mizuguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/984,996

(22) Filed: Nov. 26, 2007

(30) Foreign Application Priority Data
Dec. 5, 2006 (JP) 2006-328448

(51) Int. Cl. H04B 10/04

(52) U.S. Cl. 398/188; 375/308

(57) ABSTRACT

An optical transmitting apparatus includes a branching unit that branches light output from a light source into light beams, a phase control unit and an ABC circuit that control the phase of one of the light beams to π/2, a data processing unit that performs phase modulation on each of the light beams, phase modulating units, an interfering unit that makes the light beams on which the phase modulation has been performed interfere with each other, and a signal-generation control unit that changes the phase amount from π/2 by an amount corresponding to a desirable penalty amount.

### CROSS-REFERENCE TO RELATED APPLICATIONS

This application is based upon and claims the benefit of priority from the prior Japanese Patent Application No. 2006-328448, filed on Dec. 5, 2006, the entire contents of which are incorporated herein by reference.

### BACKGROUND OF THE INVENTION

1. Field of the Invention

The present invention relates to differential quadrature phase shift keying (DQPSK) modulation.

2. Description of the Related Art

In recent years, a demand for the introduction of a 40 Gb/s optical transmission system is increasing. In addition, a transmission distance and frequency utilization efficiency equivalent to those of a 10 Gb/s are demanded. To realize such an optical system, research and development of a return-to-zero differential phase shift keying (RZ-DPSK) modulation scheme or a carrier suppressed RZ-DPSK (CSRZ-DPSK) modulation scheme are actively promoted. The RZ-DPSK modulation scheme and the CSRZ-DPSK modulation scheme are superior to non-return to zero (NRZ) modulation schemes, which have been used in conventional systems of 10 Gb/s and lower, in terms of an optical signal noise ratio (OSNR) and tolerance for fiber nonlinearities.

In addition to the above modulation schemes, research and development of a phase modulation such as an RZ-DQPSK modulation scheme and a CSRZ-DQPSK modulation scheme having a narrow spectrum (high frequency) are also actively promoted. As for an optical receiving apparatus that demodulates an optical signal that has been modulated by the DPSK modulation scheme, an optical receiving apparatus using a delay interferometer is considered (for example, Japanese Patent Laid-Open Publication No. 2004-516743).

Furthermore, to verify validity of design of a transmission path, a penalty test is conducted. In the penalty test, a penalty signal light in which a waveform of signal light is distorted is transmitted, and an error state is monitored on a receiver side. The penalty test is usually conducted at a design stage in a test system in which an actual circuit is simulated, or is conducted while stopping the actual circuit.

However, in the penalty test that is conducted simulating an actual circuit, a characteristic of the circuit can differ from that of the actual circuit. Accordingly, the validity of design of a circuit cannot be accurately verified. On the other hand, the penalty test that is conducted while stopping the actual circuit involves high costs. Furthermore, the penalty test using the actual circuit can cause a negative effect, for example, on other channels in a wavelength division multiplexing (WDM) circuit.

### SUMMARY OF THE INVENTION

It is an object of the present invention to at least solve the problems in the conventional technologies.

A differential quadrature phase shift keying (DQPSK) modulation apparatus according to one aspect of the present invention includes a branching unit that branches light that is output from a light source into light beams; a phase control unit that controls a phase of one of the light beams to π/2; a phase modulating unit that performs phase modulation on each of the light beams; an interfering unit that makes the light beams subjected to the phase modulation interfere with each other to obtain coherent light beams; and a changing unit that changes a phase amount with which the phase of the one of the light beams is controlled from π/2 by an amount corresponding to a desirable penalty amount.

An optical transmitting apparatus according to another aspect of the present invention includes the DQPSK modulation apparatus according to the above aspect; and a transmitting unit that transmits signal light that is modulated by the DQPSK modulation apparatus.

A DQPSK modulation method according to still another aspect of the present invention includes branching light that is output from a light source into light beams; controlling a phase of one of the light beams to π/2; performing phase modulation on each of the light beams; making the light beams subjected to the phase modulation interfere with each other to obtain coherent light beams; and changing a phase amount with which the phase of the one of the light beams is controlled from π/2 by an amount corresponding to a desirable penalty amount.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of an optical transmitting apparatus according to a first embodiment of the present invention;

FIG. 2 is a schematic diagram of light in each part of the optical transmitting apparatus according to the first embodiment;

FIG. 3A illustrates a plane of polar coordinates of an electric field vector of light in each part of the optical transmitting apparatus according to the first embodiment;

FIG. 3B illustrates a plane of polar coordinates of an electric field vector of light in each part of the optical transmitting apparatus according to the first embodiment;

FIG. 4A illustrates a plane of polar coordinates of an electric field vector of coherent light in the optical transmitting apparatus according to the first embodiment when θ=π/2;

FIG. 4B is a graph showing a change of intensity of coherent light 203 in the optical transmitting apparatus according to the first embodiment when θ=π/2;

FIG. 5A illustrates a plane of polar coordinates of an electric field vector of coherent light in the optical transmitting apparatus according to the first embodiment when θ≠π/2;

FIG. 5B is a graph showing a change of intensity of the coherent light 203 in the optical transmitting apparatus according to the first embodiment when θ≠π/2;

FIG. 5C is a graph showing a change of intensity of coherent light 204 in the optical transmitting apparatus according to the first embodiment when θ≠π/2;

FIG. 6 is a graph showing relation between a phase amount θ and intensity of coherent light;

FIG. 7 is a schematic diagram showing signal light that is RZ-pulsed by an intensity modulating unit of the optical transmitting apparatus according to the first embodiment;

FIG. 8 is a block diagram of an optical receiving apparatus that corresponds to the optical transmitting apparatus according to the first embodiment;

FIG. 9 illustrates a waveform of signal light that is transmitted by the optical transmitting apparatus and received by the optical receiving apparatus according to the first embodiment;

FIG. 10 is a flowchart of a penalty test performed by the optical transmitting apparatus and the optical receiving apparatus according to the first embodiment;

FIG. 11 is a graph of intensity of the coherent light 204 that is monitored by an automatic bias control (ABC) circuit of an optical transmitting apparatus according to a second embodiment of the present invention;

FIG. 12 illustrates a waveform of signal light that is transmitted by the optical transmitting apparatus according to the second embodiment;

FIG. 13 illustrates a waveform of signal light that is transmitted by the optical transmitting apparatus and received by an optical receiving apparatus according to the second embodiment;

FIG. 14 is a flowchart of a penalty test performed by the optical transmitting apparatus and the optical receiving apparatus according to the second embodiment;

FIG. 15 illustrates a waveform of signal light that is transmitted by an optical transmitting apparatus according to a third embodiment of the present invention;

FIG. 16 illustrates a waveform of signal light that is transmitted by the optical transmitting apparatus and received by an optical receiving apparatus according to the third embodiment;

FIG. 17 illustrates a waveform of signal light that is transmitted by an optical transmitting apparatus and received by an optical receiving apparatus according to a fourth embodiment of the present invention; and

FIG. 18 illustrates a waveform of signal light that is transmitted by an optical transmitting apparatus and received by an optical receiving apparatus according to a fifth embodiment of the present invention.

### DETAILED DESCRIPTION OF THE PREFERRED EMBODIMENTS

Exemplary embodiments according to the present invention are explained in detail below with reference to the accompanying drawings.

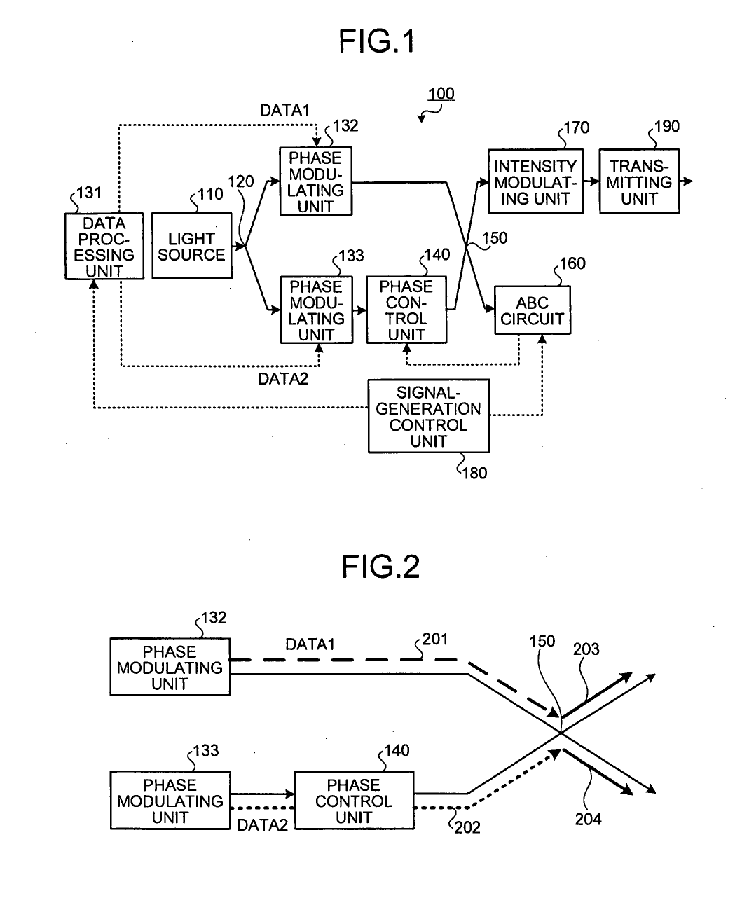

FIG. 1 is a block diagram of an optical transmitting apparatus according to a first embodiment of the present invention. As shown in FIG. 1, an optical transmitting apparatus 100 includes a light source 110, a branching unit 120, a data processing unit 131, a phase modulating unit 132, a phase modulating unit 133, a phase control unit 140, an interfering unit 150, an ABC circuit 160, an intensity modulating unit 170, a signal-generation control unit 180, and a transmitting unit 190.

The light source 110 outputs light to the branching unit 120. The branching unit 120 branches the light output from the light source 110, and outputs one of light beams obtained by branching to the phase modulating unit 132, and the other to the phase modulating unit 133. The data processing unit 131 generates data1 and data2 that are binary data code strings, and outputs the data1 to the phase modulating unit 132, and the data2 to the to the phase modulating unit 133. The data processing unit 131 outputs the data1 and the data2 and stops the output thereof, in accordance with a control of the signal-generation control unit 180.

The phase modulating unit 132 performs binary phase modulation on the light beam output from the branching unit 120, based on the data1. The phase modulating unit 132 outputs the signal light beam on which the phase modulation has been performed to the interfering unit 150. The phase modulating unit 133 performs binary phase modulation on the light beam output from the branching unit 120, based on the data2. The phase modulating unit 133 outputs the signal light beam on which the phase modulation has been performed to the phase control unit 140.

The phase control unit 140 controls a phase of the signal light beam output from the phase modulating unit 133 according to a control of the ABC circuit 160, and outputs the signal light beam to the interfering unit 150. Specifically, the phase control unit 140 delays the phase of the signal light beam that is output from the phase modulating unit 133 relative to the signal light beam that is output from the phase modulating unit 132 by θ. The interfering unit 150 makes the signal light beams output from the phase modulating unit 132 and the phase control unit 140 interfere with each other, and outputs coherent light beams thus obtained to the intensity modulating unit 170 and the ABC circuit 160.

The ABC circuit 160 adjusts a phase amount θ that is controlled by the phase control unit 140, based on the coherent light beams output from the interfering unit 150. Specifically, the ABC circuit 160 monitors the intensity of the coherent light beams and automatically controls such that the phase amount θ becomes a predetermined amount.

Moreover, the ABC circuit 160 changes the phase amount θ under the control of the signal-generation control unit 180. The intensity modulating unit 170 converts the coherent light beams into RZ-pulsed signal light beams. The RZ-pulsed signal light beams are transmitted to a receiving apparatus by the transmitting unit 190.

When a regular signal light is to be generated, the signal-generation control unit 180 controls the ABC circuit 160 to adjust the phase amount θ of signal light. When a penalty signal light that is obtained by distorting a regular signal light is to be generated, the signal-generation control unit 180 controls the ABC circuit 160 to change the phase amount θ from π/2 by an amount corresponding to a desirable penalty amount.

With the configuration described above, a DQPSK modulation apparatus according to the embodiments of the present invention is formed. Moreover, by adding the transmitting unit 190 to the DQPSK modulating apparatus according to the embodiments, the optical transmitting apparatus 100 is formed. While in this example, the phase modulating unit 133 is arranged on a side of the branching unit 120 and the phase control unit 140 is arranged on a side of the interfering unit 150, the phase modulating unit 133 can be arranged on the side of the interfering unit 150, and the phase control unit 140 can be arranged on the side of the branching unit 120.

FIG. 2 is a schematic diagram of light in each part of the optical transmitting apparatus according to the first embodiment. Light 201 is the light beam on which the phase modulation has been performed by the phase modulating unit 132 based on the data1. Light 202 is the light beam on which the phase modulation has been performed by the phase modulating unit 133 based on the data2, and controlled by the phase control unit 140 by the phase amount θ.

The two coherent light beams that are the light 201 and the light 202 caused to interfere with each other and output by the interfering unit 150 are coherent light 203 and coherent light 204. The coherent light 203 is output to the intensity modulating unit 170. The coherent light 204 is output to the ABC circuit 160. The intensity of the light 201 is C milliwats (mW), and the intensity of the light 202 is D mW. In this case, electric field vectors of the light 201 and the light 202 are √C and √D, respectively.

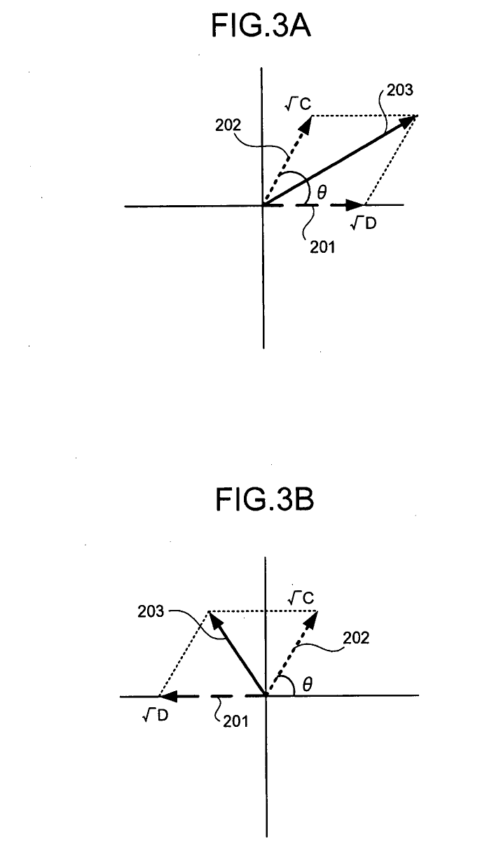

FIG. 3A illustrates a plane of polar coordinates of an electric field vector of light in each part of the optical transmitting apparatus according to the first embodiment. FIG. 3B illustrates another plane of polar coordinates of an electric field vector of light in each part of the optical transmitting apparatus according to the first embodiment. As shown in FIG. 3A, since the light 202 is controlled by the phase control unit 140 by the phase amount θ relative to the light 201, the phase of the light 202 is rotated by θ relative to the light 201 on the plane of the polar coordinates.

The electric field vector of the coherent light 203 is expressed as a combined vector of the electric field vector of the light 201 and the electric field vector of the light 202. The coordinates of the coherent light 203 on the plane of the polar coordinates are (√D+√C·cos θ, √C·sin θ). When the phase of the light 201 is rotated by π by reversal of the value of the data1 as shown in FIG. 3B, the coordinates of the coherent light 203 are (−√D+√C·cos θ, √C·sin θ).

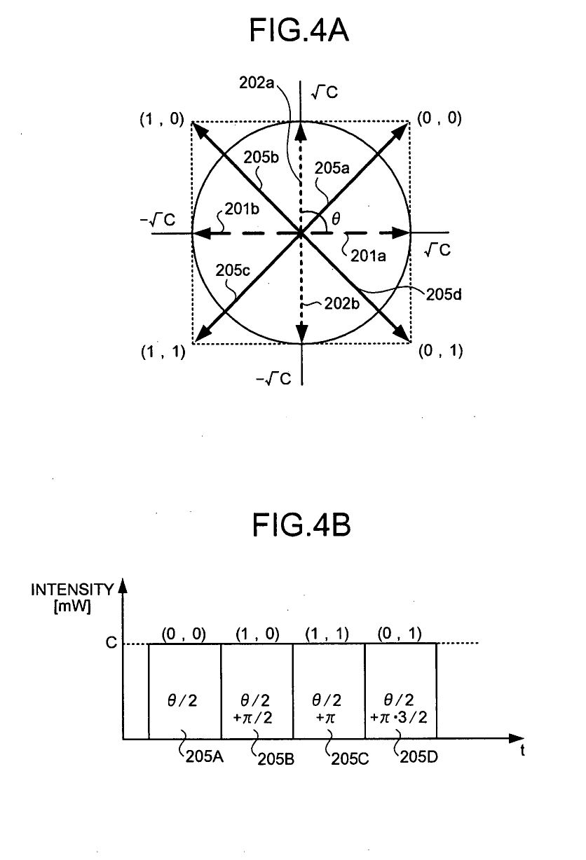

FIG. 4A illustrates a plane of polar coordinates of an electric field vector of coherent light in the optical transmitting apparatus according to the first embodiment, when θ≠π/2. FIG. 4A shows the coherent light 203 when the phase amount at the time of controlling light by the phase control unit 140 is θ=π/2 and C=D. The light 201 is to be as light 201a when the data1=0, and is to be as light 201b when the data1=1. The light 202 is to be as light 202a when the data2=0, and to be as light 202b when the data2=1.

Coherent light 205 that is coherent light in which the light 201 and the light 202 interfere with each other before being branched into the coherent light 203 and the coherent light 204 takes four kinds of values depending on combinations of the data1 and the data2. When (data1, data2)=(0, 0), (1, 0), (1, 1), and (0, 1), the coherent light 205 are to be as coherent light 205a, 205b, 205c, and 205d.

Generally, when (data1, data2)=(0, 0), (1, 1), vectors of the coherent light 205a and the coherent light 205c are 2√C·cos(θ/2). When (data1, data2)=(1, 0), (0, 1), vectors of the coherent light 205b and the coherent light 205d are 2√C·sin(θ/2). In this example, since θ=π/2, the vector of the coherent light 205 is always 2√C·cos(π/4)=2√C·sin(π/4)=√2·√C regardless of the value of the data1 and the data2.

FIG. 4B is a graph showing a change of intensity of the coherent light 203 in the optical transmitting apparatus according to the first embodiment, when θ=π/2. FIG. 4B shows a change in intensity of the coherent light 203 when phase modulation is performed in the order of (data1, data2)=(0, 0), (1, 0), (1, 1), (0, 1). Coherent light 205A to 205D correspond to the coherent light 205a to 205d shown in FIG. 4A, respectively. When the phase modulation is performed in this order, the coherent light 205 changes in the order of the coherent light 205A, 205B, 205C, and 205D (see FIG. 4A).

The intensity of the coherent light 205 is always (√2·√C)2=2C regardless of the values of the data1 and the data2. The coherent light 205 is branched into the coherent light 203 and the coherent light 204 at the branching unit 150, and the intensity of the coherent light 203 is always C. In this case, the intensity of the coherent light 204 changes similarly to the coherent light 203, and the intensity of the coherent light 204 is also always C.

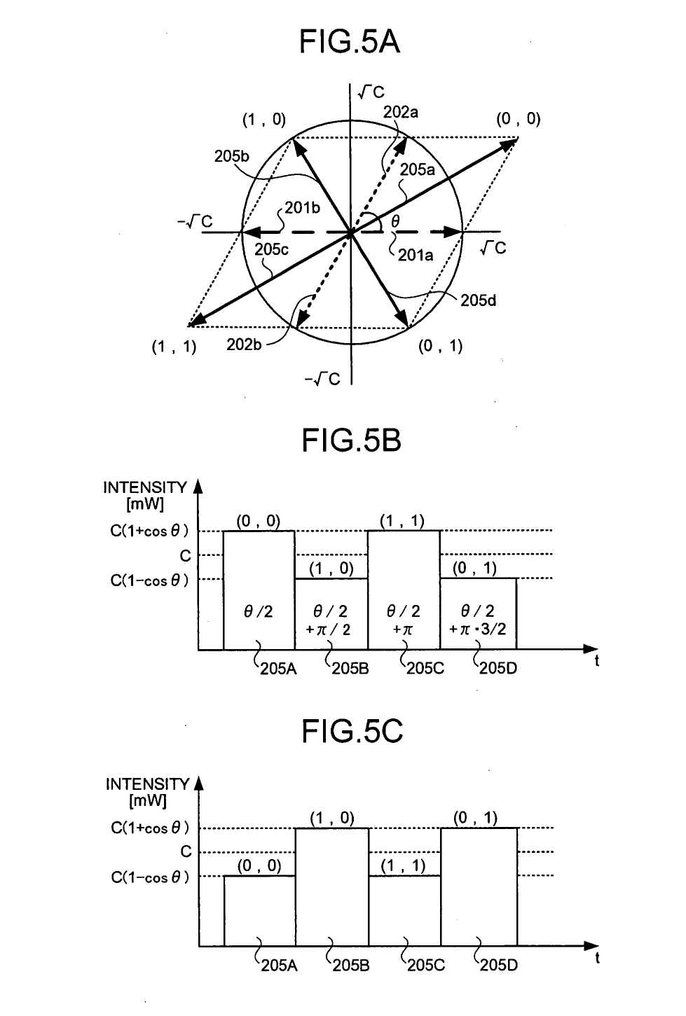

FIG. 5A illustrates a plane of polar coordinates of an electric field vector of coherent light in the optical transmitting apparatus according to the first embodiment, when θ≠π/2. FIG. 5A shows the coherent light 205 when the phase amount at the time of controlling light by the phase control unit 140 is θ≠π/2 and C=D. When the phase amount θ≠π/2, the vector of the coherent light 205a and the coherent light 205c, which is 2√C·cos(θ/2), and the vector of the coherent light 205b and the coherent light 205d, which is 2√C·sin(θ/2), are different values.

For example, when the phase amount θ=π/3, the vector of the coherent light 205a and the coherent light 205c is 2√C·cos(θ/2)=2√C·cos(π/6)=√3·√C. The vector of the coherent light 205b and the coherent light 205d is 2√C·sin(θ/2)=2/√C·sin(π/6)=√C.

FIG. 5B is a graph showing a change of intensity of the coherent light 203 in the optical transmitting apparatus according to the first embodiment, when θ≠π/2. FIG. 5C is a graph showing a change of intensity of the coherent light 204 in the optical transmitting apparatus according to the first embodiment, when θ≠π/2. FIG. 5B shows a change in intensity of the coherent light 203 when phase modulation is performed in the order of (data1, data2)=(0, 0), (1, 0), (1, 1), (0, 1), similarly to FIG. 4B.

The change in intensity of the coherent light 203 when the phase amount at the time of controlling light by the phase control unit 140 is θ≠π/2 is shown herein. The intensity of the coherent light 205A and the coherent light 205C is 2C(1+cos θ). Therefore, when the coherent light 205 is the coherent light 205A and 205C, the intensity of the coherent light 203 is to be C(1+cos θ).

When the coherent light 205 is the coherent light 205B and 205D, the intensity of the coherent light 203 is to be C(1−cos θ). When the phase modulation is performed in the order described above, the intensity of the coherent light 203 changes alternately as C(1+cos θ), C(1−cos θ), C(1+cos θ), C(1−cos θ), and an average of the intensity of the coherent light 203 is C, similarly to the case where the phase amount θ=π/2 (see FIG. 4B).

When the coherent light 205 is the coherent light 205A and the coherent light 205C, the intensity of the coherent light 204 is to be C(1−cos θ) as shown in FIG. 5C. When the coherent light 205 is the coherent light 205B and the coherent light 205D, the intensity of the coherent light 204 is to be C(1+cos θ). When the phase modulation is performed in the order described above, the intensity of the coherent light 204 changes alternately as C(1−cos θ), C(1+cos θ), C(1−cos θ), C(1+cos θ).

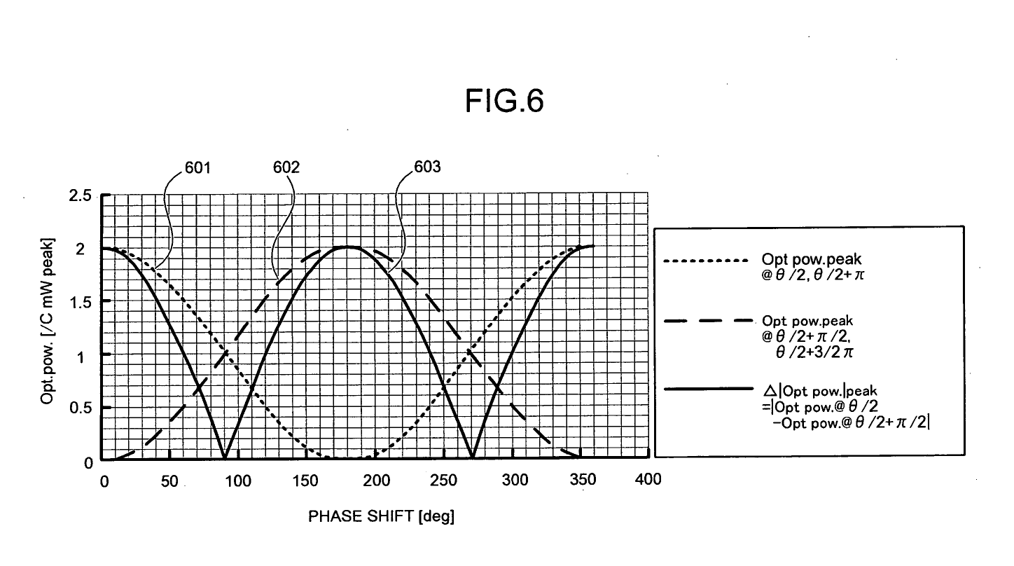

FIG. 6 is a graph showing relation between a phase amount θ and intensity of coherent light. The horizontal axis represents the phase amount θ, and the vertical axis indicates a peak of the intensity of coherent light. An intensity characteristic 601 shown in FIG. 6 indicates an intensity characteristic of the coherent light 205a and the coherent light 205c with respect to the phase amount θ. An intensity characteristic 602 indicates an intensity characteristic of the coherent light 205b and the coherent light 205d with respect to the phase amount θ.

A numeral 603 indicates a difference in intensity between the coherent light 205a and the coherent light 205c and the coherent light 205b and the coherent light 205d. In the actual data communication, by setting the phase amount θ to π/2, π·3/2, . . . , the difference 603 becomes 0, and signal light having stable intensity can be generated regardless of the values of the data1 and data2.

Moreover, in the penalty test, by setting the phase amount to a value other than π/2, π·3/2, . . . , the difference 603 becomes not 0, and the penalty signal in which the intensity varies depending on the values of the data1 and the data2 can be generated. If the phase amount θ is set to 0, π, 2π, . . . , the difference 603 becomes the maximum value.

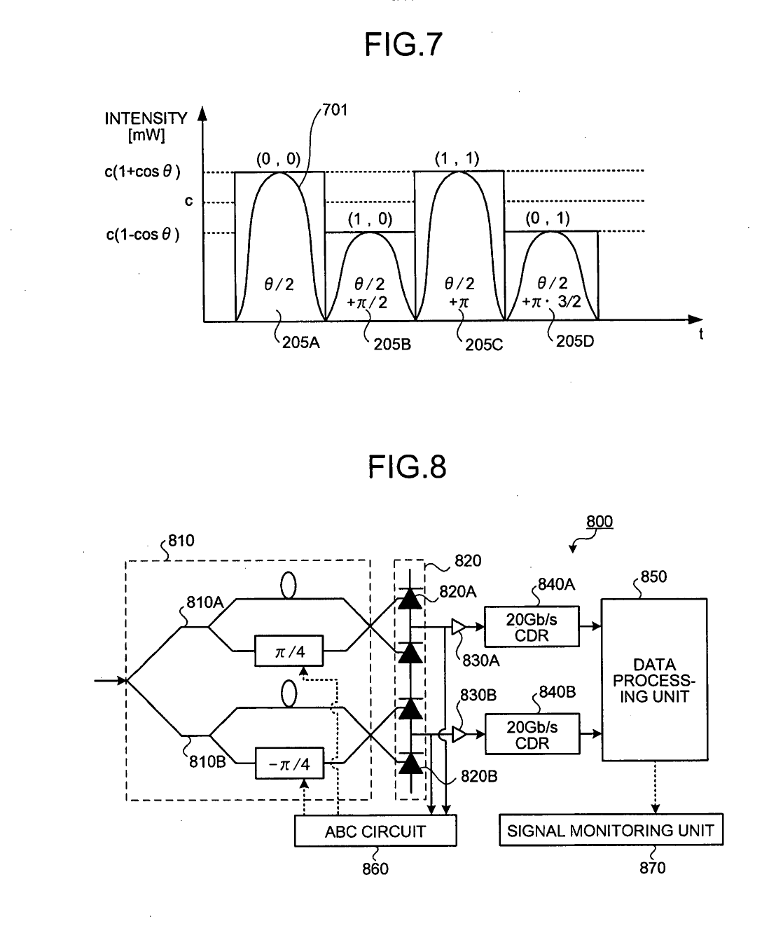

FIG. 7 is a schematic diagram showing signal light that is RZ-pulsed by the intensity modulating unit of the optical transmitting apparatus according to the first embodiment. As shown in FIG. 7, in a waveform of signal light 701 that is RZ-pulsed by the intensity modulating unit 170, the intensity at a boundary at which the phase changes is nearly 0 mW. Thus, by keeping the optical power at a portion at which an optical phase angle abruptly changes low, waveform distortion that occurs after optical transmission can be reduced.

FIG. 8 is a block diagram of an optical receiving apparatus that corresponds to the optical transmitting apparatus according to the first embodiment. As shown in FIG. 8, an optical receiving apparatus 800 corresponding to the optical transmitting apparatus 100 includes a delay interferometer 810, a photoelectric converter 820, recovery units 840A and 840B, a data processing unit 850, an ABC circuit 860, and a signal monitoring unit 870.

The delay interferometer 810 causes delay and interference in signal light received from the optical receiving apparatus 100, and outputs the signal light to the photoelectric converter 820. Specifically, the delay interferometer 810 includes arms 810A and 810B, and branches the DQPSK signal light to respectively input to the arms 810A and 810B.

The arm 810A further branches the signal light, and delays one of the branched signal light to be delayed by 1 bit, and controls the other one for π/4, to cause the branched signal light to interfere with each other. The arm 810B further branches the signal light, and delays one of the branched signal light by 1 bit, and controls the other one for −π/4, to cause the branched signal light to interfere with each other. The arms 810A and 810B respectively output coherent light thus obtained to the photoelectric converter 820.

The photoelectric converter 820 receives the coherent light output from the delay interferometer 810, and performs photoelectric conversion on the received coherent light to output to the recovery units 840A and 840B. Specifically, the photoelectric converter 820 has a dual pin photodiode 820A and a dual pin photo diode 820B. The dual pin photodiode 820A receives two coherent light beams output from the arm 810A and converts the coherent light beams into an electrical signal to send to the recovery unit 840A.

The dual pin photodiode 820B receives two coherent light beams output from the arm 810B, and converts the coherent light beams into an electrical signal to send to the recovery unit 840B. The electrical signals sent to the recovery units 840A and 840B from the dual pin photodiodes 820A and 820B are amplified by amplifiers 830A and 830B, respectively.

The recovery units 840A and 840B, which is a clock and data recovery (CDR), recovers a data signal based on the electrical signals received from the photoelectric converter 820, and outputs the recovered data signal to the data processing unit 850. The recovery unit 840A recovers an I (in-phase) component from the electrical signal received from the dual pin photodiode 820A, to send to the data processing unit 850. The recovery circuit 840B recovers a Q (quadrature-phase) component from the electrical signal received from the dual pin photodiode 820B, to send to the data processing unit 850.

The data processing unit 850 demodulates the data signal based on the I component and the Q component, and performs a logical processing such as error correction based on the demodulated data signal. The ABC circuit 860 adjusts the control phase amount of the arms 810A and 810B based on the electrical signals output from the photoelectric converter 820.

The signal monitoring unit 870 monitors an error state of the data signal demodulated by the data processing unit 850. For example, the signal monitoring unit 870 monitors a bit error rate (BER) of the data signal by monitoring an error correction bit count by forward error correction (FEC). Moreover, the signal monitoring unit 870 obtains a result of the penalty test by monitoring a BER of a penalty signal.

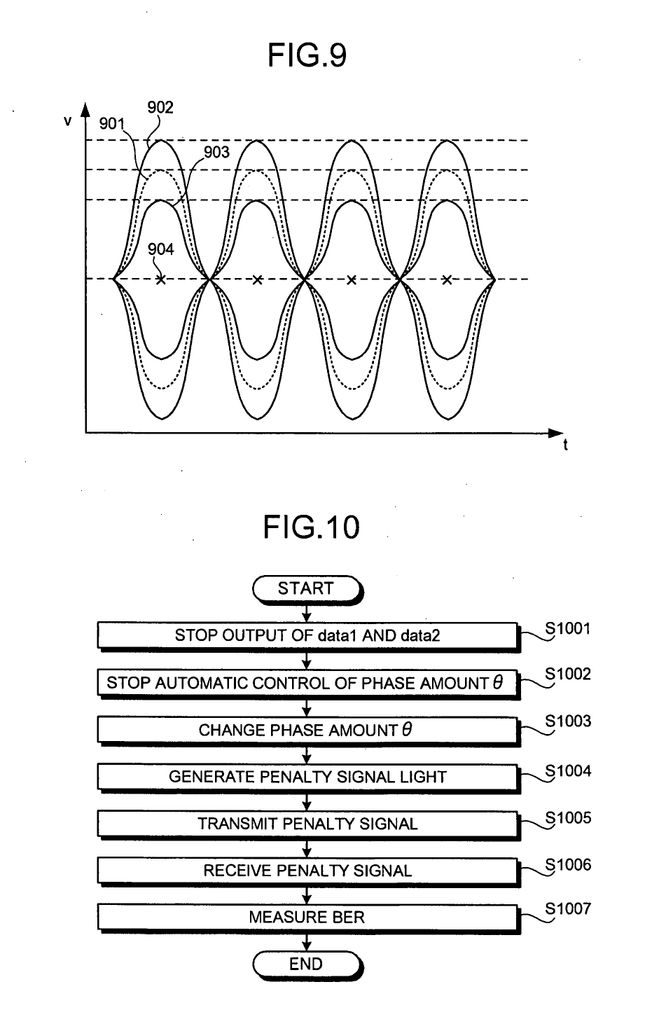

FIG. 9 illustrates a waveform of signal light that is transmitted by the optical transmitting apparatus and received by the optical receiving apparatus according to the first embodiment. Signal light 901 shown in FIG. 9 is regular signal light that is transmitted from the optical transmitting apparatus 100. Signal light 902 is signal light in which the coherent light 205 is the coherent light 205A and 205C (see FIG. 7). Signal light 903 is signal light in which the coherent light 205 is the coherent light 205B and 205D.

The optical receiving apparatus 800 measures the intensity of signal light at an identification point 904, to identify the signal light. As shown in FIG. 9, signal light 902 has higher intensity than signal light 901. Signal light 903 has lower intensity than the signal light 901. Thus, the signal light 902 and 903 become penalty signal light having a penalty in intensity.

FIG. 10 is a flowchart of a penalty test performed by the optical transmitting apparatus and the optical receiving apparatus according to the first embodiment. As shown in FIG. 10, first, the signal-generation control unit 180 stops the output of the data1 and the data2 from the data processing unit 131 (step S1001). The signal-generation control unit 180 then stops the automatic control of the phase amount θ by the ABC circuit 160 (step S1002).

Subsequently, the signal-generation control unit 180 changes the phase amount θ controlled by the ABC circuit 160 from π/2 by a predetermined amount (step S1003). Next, the signal-generation control unit 180 generates penalty signal light by causing the data processing unit 131 to output the data1 and the data2 (step S1004). The optical transmitting apparatus 100 transmits the penalty signal light to the optical receiving apparatus 800 (step S1005).

The optical receiving apparatus 800 receives and demodulates the penalty signal light (step S1006). Subsequently, the signal monitoring unit 870 measures the BER (step S1007). Thus, a series of processes is ended. With the processes described above, the penalty test of a transmission path between the optical transmitting apparatus 100 and the optical receiving apparatus 800 can be conducted.

As described, according to the optical transmitting apparatus 100 of the first embodiment, penalty signal light having a penalty in intensity can be generated by setting the phase amount θ to θ≠π/2.

Furthermore, according to the optical transmitting apparatus 100 of the first embodiment, penalty signal light having the same intensity as that of regular signal light can be transmitted. Therefore, a penalty test can be conducted without affecting other channels in a WDM circuit.

The signal-generation control unit 180 of the optical transmitting apparatus 100 according to a second embodiment of the present invention sets the phase amount θ of the phase control unit 140 that is adjusted by the ABC circuit 160 to 0, and performs phase modulation setting the data1 and the data2 as identical alternating values. Specifically, the data1 and the data2 are changed as (data1, data2)=(1, 1), (0, 0), (1, 1), (0, 0), . . . .

Moreover, the signal-generation control unit 180 can set the phase amount θ to π, and can perform phase modulation setting the data1 and the data2 as alternating values that differ between the data1 and the data2. Specifically, the data1 and the data2 are changed as (data1, data2)=(1, 0), (0, 1), (1, 0), (0, 1), . . . .

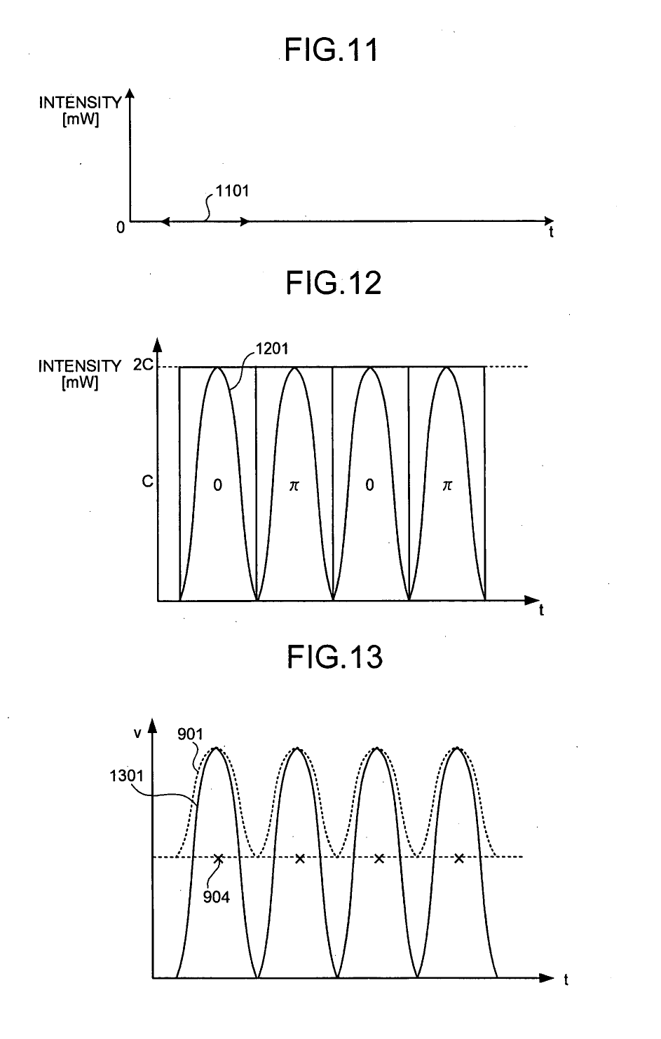

FIG. 11 is a graph of intensity of the coherent light 204 that is monitored by the ABC circuit of the optical transmitting apparatus according to the second embodiment. As shown in FIG. 11, intensity 1101 of the coherent light 204 that is monitored by the ABC circuit 160 is always 0 mW or a value close to 0 mW. Therefore, the ABC circuit 160 adjusts the phase amount θ such that the intensity of the coherent light 204 always becomes 0 or a smallest value close to 0.

FIG. 12 illustrates a waveform of signal light that is transmitted by the optical transmitting apparatus according to the second embodiment. As shown in FIG. 12, signal light 1201 transmitted by the optical transmitting apparatus 100 changes in the phase by π. Therefore, the value indicated by the signal light 1201 is always 1111. The intensity of the signal light 1201 is always 2C.

FIG. 13 illustrates a waveform of signal light that is received by an optical receiving apparatus according to the second embodiment. As shown in FIG. 13, the intensity of signal light 1301 received by the optical receiving apparatus 800 becomes twice as high as that in a normal time, and shifts in the lower direction of intensity than the normal time by alternating current (AC) coupling after transimpedance amplifier (TIA) output of an RZ waveform (refer to 820A, 820B, 830A, 830B of FIG. 8). This narrows pulse width of the signal light 1301 at the identification point 904. Therefore, the signal light 1301 becomes penalty signal light having a penalty in phase.

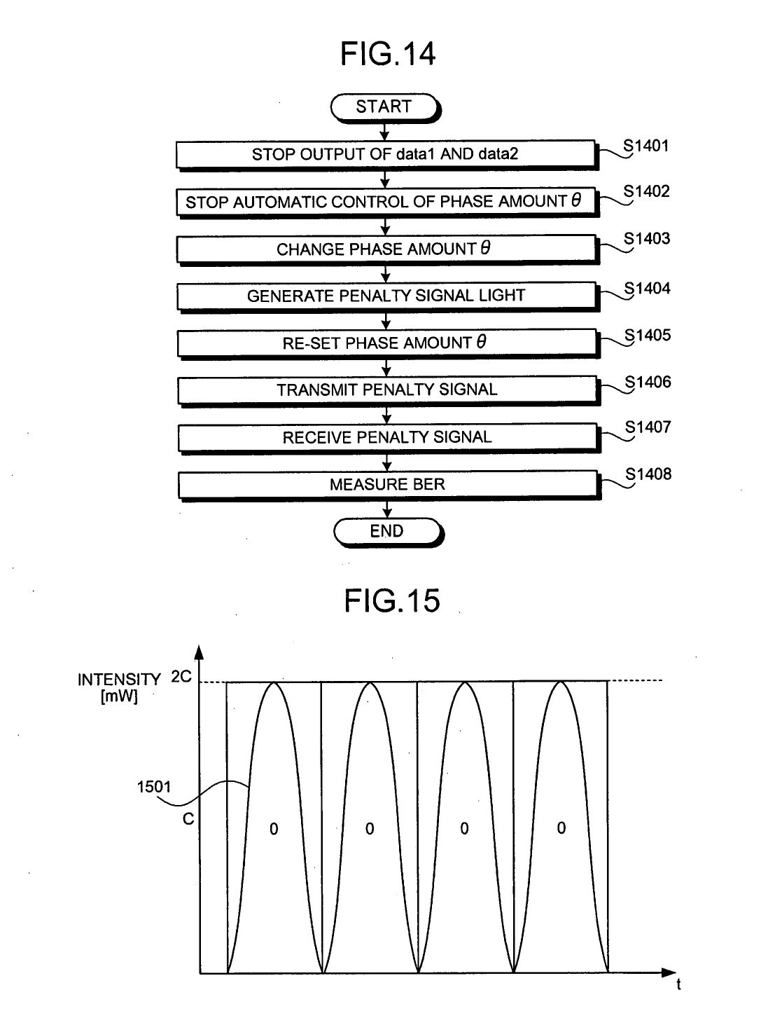

FIG. 14 is a flowchart of a penalty test performed by the optical transmitting apparatus and the optical receiving apparatus according to the second embodiment. As shown in FIG. 14, first, the signal-generation control unit 18 stops the output of the data1 and the data2 from the data processing unit 131 (step S1401). The signal-generation control unit 180 then stops the automatic control of the phase amount θ by the ABC circuit 160 (step S1402). Subsequently, the signal-generation control unit 180 changes the phase amount θ to 0 or π (step S1403).

Next, the signal-generation control unit 180 generates penalty signal light by outputting the data1 and the data 2 to the data processing unit 131 (step S1404). The ABC circuit 160 re-sets the phase amount θ of the phase control unit 140 so that the intensity of the coherent light 204 becomes 0 mW or a value close to 0 mW (step 1405).

The optical transmitting apparatus 100 transmits the penalty signal light to the optical receiving apparatus 800 (step S1406). The optical receiving unit 800 receives and demodulates the penalty signal (step S1407). Next, the signal monitoring unit 870 measures the BER (step S1408). Thus, a series of processes is ended. With the processes described above, the penalty test of a transmission path between the optical transmitting apparatus 100 and the optical receiving unit 800 can be conducted.

As described, according to the optical transmitting apparatus 100 of the second embodiment, by setting the phase amount θ that is controlled by the ABC circuit 160 to 0 or π, and by performing the phase modulation setting the data1 and the data2 as alternating values, penalty signal light having a penalty in phase can be transmitted.

The signal-generation control unit 180 of the optical transmitting apparatus 100 according to a third embodiment of the present invention sets the phase amount θ of the phase control unit 140 that is adjusted by the ABC circuit 160 to 0, and performs phase modulation setting the data1 and the data2 as identical values. Specifically, the data1 and the data2 are changed as (data1, data2)=(1, 1), (1, 1), (1, 1), (1, 1), . . . , or (data1, data2)=(0, 0), (0, 0), (0, 0), (0, 0) . . . .

Moreover, the signal-generation control unit 180 can set the phase amount θ to π, and can perform phase modulation setting the data1 and the data2 as respectively identical values that differ between the data1 and the data2. Specifically, the data1 and the data2 are changed as (data1, data2)=(1, 0), (1, 0), (1, 0), (1, 0), . . . , or (data1, data2)=(0, 1), (0, 1), (0, 1), (0, 1), . . . .

FIG. 15 illustrates a waveform of signal light that is transmitted by an optical transmitting apparatus according to the third embodiment. As shown in FIG. 15, the phase of signal light 1501 that is transmitted by the optical transmitting apparatus 100 according to the third embodiment does not change. Therefore, the value indicated by the signal light 1501 is always 0000. Moreover, the intensity of the signal light 1501 is always 2C.

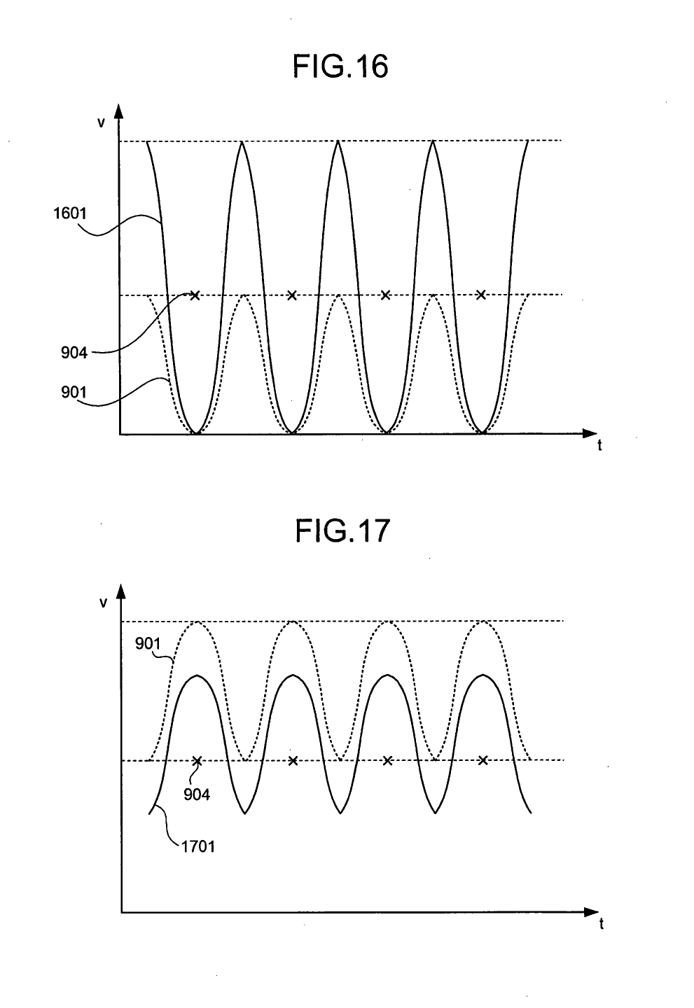

FIG. 16 illustrates a waveform of signal light that is transmitted by the optical transmitting apparatus and received by an optical receiving apparatus according to the third embodiment. As shown in FIG. 16, the intensity of signal light 1601 received by the optical receiving apparatus 800 becomes twice as high as that in a normal time, and shifts in the higher direction of intensity than the normal time by AC coupling after TIA output of an RZ waveform. This narrows pulse width of the signal light 1601 at the identification point 904. Therefore, the signal light 1601 becomes penalty signal light having a penalty in phase.

Also in the optical transmitting apparatus 100 according to the third embodiment, the intensity of the coherent light 204 that is monitored by the ABC circuit 160 is always 0 mW (see FIG. 11). Therefore, the ABC circuit 160 adjusts the phase amount θ of the phase control unit 140 such that the intensity of the coherent light 204 always becomes 0 or a smallest value close to 0.

As described, according to the optical transmitting apparatus 100 of the third embodiment, by setting the phase amount θ that is controlled by the ABC circuit 160 to 0 or π, and by performing the phase modulation setting the data1 and the data2 as respectively identical values, penalty signal light having a penalty in phase can be transmitted.

The operation in the penalty test performed by the optical transmitting apparatus 100 and the optical receiving apparatus 800 according to the third embodiment is the same as the operation in the penalty test performed by the optical transmitting apparatus 100 and the optical receiving apparatus 800 according to the second embodiment (see FIG. 14). Therefore, the explanation thereof is omitted herein.

The signal-generation control unit 180 of the optical transmitting apparatus 100 according to a fourth embodiment of the present invention sets the phase amount θ of the phase control unit 140 that is adjusted by the ABC circuit 160 to π/2, and performs phase modulation setting the data1 and the data2 as identical alternating values. Specifically, the data1 and the data2 are changed as (data1, data2)=(1, 1), (0, 0), (1, 1), (0, 0), . . . .

Moreover, the signal-generation control unit 180 can set the phase amount θ to π·3/2, and can perform phase modulation setting the data1 and the data2 as alternating values that differ between the data1 and the data2. Specifically, the data1 and the data2 are changed as (data1, data2)=(1, 0), (0, 1), (1, 0), (0, 1), . . . .

The waveform of signal light that is output by the optical transmitting apparatus 100 according to the fourth embodiment is the same as that of the signal light output by the optical transmitting apparatus 100 according to the second embodiment (see FIG. 11). Therefore, illustration thereof is omitted herein. The phase of the signal light transmitted by the optical transmitting apparatus 100 according to the fourth embodiment changes by π. Therefore, the value indicated by the signal light is always 1111. Moreover, the intensity of the signal light is always 2C.

FIG. 17 illustrates a waveform of signal light that is transmitted by the optical transmitting apparatus and received by an optical receiving apparatus according to the fourth embodiment. As shown in FIG. 17, the intensity of signal light 1701 received by the optical receiving apparatus 800 becomes as high as that in a normal time, and shifts in the lower direction of intensity than the normal time by AC coupling after TIA output of an RZ waveform. This narrows pulse width of the signal light 1701 at the identification point 904. Therefore, the signal light 1701 becomes penalty signal light having a penalty in intensity and in phase.

As described, according to the optical transmitting apparatus 100 of the fourth embodiment, by setting the phase amount θ that is controlled by the ABC circuit 160 to π/2 or π·3/2, and by performing the phase modulation setting the data1 and the data2 as alternating values, penalty signal light having a penalty in intensity and in phase can be transmitted. Furthermore, according to the optical transmitting apparatus 100 of the fourth embodiment, penalty signal light having the intensity as high as normal time can be transmitted. Therefore, a penalty test can be conducted without affecting other channels in a WDM circuit.

The operation in the penalty test performed by the optical transmitting apparatus 100 and the optical receiving apparatus 800 according to the fourth embodiment is the same as the operation in the penalty test performed by the optical transmitting apparatus 100 and the optical receiving apparatus 800 according to the first embodiment (see FIG. 10). Therefore, the explanation thereof is omitted herein.

The signal-generation control unit 180 of the optical transmitting apparatus 100 according to a fifth embodiment of the present invention sets the phase amount θ of the phase control unit 140 that is adjusted by the ABC circuit 160 to π/2, and performs phase modulation setting the data1 and the data2 as identical values. Specifically, the data1 and the data2 are changed as (data1, data2)=(1, 1), (1, 1), (1, 1), (1, 1), . . . , or (data1, data2)=(0, 0), (0, 0), (0, 0), (0, 0) . . . .

Moreover, the signal-generation control unit 180 can set the phase amount θ to π/2, and can perform phase modulation setting the data1 and the data2 as respectively identical values that differ between the data1 and the data2. Specifically, the data1 and the data2 are changed as (data1, data2)=(1, 0), (1, 0), (1, 0), (1, 0), . . . , or (data1, data2)=(0, 1), (0, 1), (0, 1), (0, 1), . . . .

Furthermore, the signal-generation control unit 180 of the optical transmitting apparatus 100 according to the fifth embodiment of the present invention sets the phase amount θ of the phase control unit 140 that is adjusted by the ABC circuit 160 to π·3/2, and performs phase modulation setting the data1 and the data2 as identical values. Specifically, the data1 and the data2 are changed as (data1, data2)=(1, 1), (1, 1), (1, 1), (1, 1), . . . , or (data1, data2)=(0, 0), (0, 0), (0, 0), (0, 0) . . . .

Moreover, the signal-generation control unit 180 can set the phase amount θ to π·3/2, and can perform phase modulation setting the data1 and the data2 as respectively identical values that differ between the data1 and the data2. Specifically, the data1 and the data2 are changed as (data1, data2)=(1, 0), (1, 0), (1, 0), (1, 0), . . . , or (data1, data2)=(0, 1), (0, 1), (0, 1), (0, 1) . . . .

The waveform of signal light that is output by the optical transmitting apparatus 100 according to the fifth embodiment is the same as that of the signal light output by the optical transmitting apparatus 100 according to the third embodiment (see FIG. 15). Therefore, illustration thereof is omitted herein. The phase of the signal light transmitted by the optical transmitting apparatus 100 according to the fifth embodiment does not change. Therefore, the value indicated by the signal is always 0000. Moreover, the intensity of the signal light is always 2C.

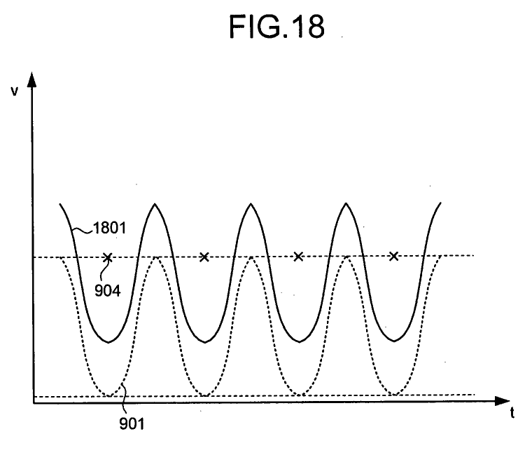

FIG. 18 illustrates a waveform of signal light that is transmitted by the optical transmitting apparatus and received by an optical receiving apparatus according to the fifth embodiment. As shown in FIG. 18, the intensity of signal light 1801 received by the optical receiving apparatus 800 becomes as high as that in a normal time, and shifts in the higher direction of intensity than the normal time by AC coupling after TIA output of an RZ waveform. This narrows pulse width of the signal light 1801 at the identification point 904. Therefore, the signal light 1801 becomes penalty signal light having a penalty in intensity and in phase.

As described, according to the optical transmitting apparatus 100 of the fifth embodiment, by setting the phase amount θ that is controlled by the ABC circuit 160 to π/2 or π·3/2, and by performing the phase modulation setting the data1 and the data2 as alternating values or respectively identical values, penalty signal light having a penalty in intensity and in phase can be transmitted. Furthermore, according to the optical transmitting apparatus 100 of the fifth embodiment, penalty signal having the intensity as high as normal time can be transmitted. Therefore, a penalty test can be conducted without affecting other channels in a WDM circuit.

The operation in the penalty test performed by the optical transmitting apparatus 100 and the optical receiving apparatus 800 according to the fifth embodiment is the same as the operation in the penalty test performed by the optical transmitting apparatus 100 and the optical receiving apparatus 800 according to the first embodiment (see FIG. 10). Therefore, the explanation thereof is omitted herein.

As described above, according to the DQPSK modulation apparatus, the optical transmitting apparatus, and the DQPSK modulation method of the present invention, the validity of design of a circuit can be accurately verified without stopping an actual circuit.

The optical transmitting apparatus 100 according to the first embodiment can be configured without the intensity modulating unit 170 because the penalty signal light having a penalty only in intensity is generated. Moreover, although the case where the signal light that is generated by the optical transmitting apparatus 100 according to the second to the fifth embodiments is used as penalty signal light has been explained, the application of the optical transmitting apparatus 100 according to the second to the fifth embodiments is not limited thereto. For example, the signal light generated by the optical transmitting apparatus 100 according to the second to the fifth embodiments can be used as an alarming signal.

According to the embodiments described above, the validity of design of a circuit can be accurately verified without stopping an actual circuit.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A differential quadrature phase shift keying (DQPSK) modulation apparatus, comprising:
a branching unit that branches light output from a light source into light beams;
a phase control unit that controls a phase of one of the light beams to π/2;
a phase modulating unit that performs phase modulation on each of the light beams;
an interfering unit that makes the light beams subjected to the phase modulation interfere with each other to obtain coherent light beams; and
a changing unit that changes a phase amount by which the phase of the one of the light beams is controlled from π/2 by an amount corresponding to a desirable penalty amount.

2. The DQPSK modulation apparatus according to claim 1, further comprising a generating unit that generates two data code strings, wherein
the phase modulating unit performs the phase modulation using the two code strings, and
the changing unit changes the phase amount to any one of 0 and π.

3. The DQPSK modulation apparatus according to claim 2, wherein the two data code strings are constituted of alternating values.

4. The DQPSK modulation apparatus according to claim 3, wherein
the two data code strings are identical, and
the changing unit changes the phase amount to 0.

5. The DQPSK modulation apparatus according to claim 3, wherein
the two data code strings are different, and
the changing unit changes the phase amount to π.

6. The DQPSK modulation apparatus according to claim 2, wherein the two data code strings have identical values, respectively.

7. The DQPSK modulation apparatus according to claim 6, wherein
the two data code strings are identical, and
the changing unit changes the phase amount to 0.

8. The DQPSK modulation apparatus according to claim 6, wherein
the two data code strings are different, and
the changing unit changes the phase amount to π.

9. The DQPSK modulation apparatus according to claim 1, further comprising a generating unit that generates two data code strings that are constituted of alternating values, wherein
the phase modulating unit performs the phase modulation using the two code strings, and
the changing unit changes the phase amount to any one of π/2 and π·3/2.

10. The DQPSK modulation apparatus according to claim 9, wherein
the two code strings are identical, and
the changing unit changes the phase amount to π/2.

11. The DQPSK modulation apparatus according to claim 9, wherein
the two code strings are different, and
the changing unit changes the phase amount to π·3/2.

12. The DQPSK modulation apparatus according to claim 1, further comprising a generating unit that generates two data code strings that are constituted of respectively identical values, wherein
the phase modulating unit performs the phase modulation using the two code strings, and
the changing unit changes the phase amount to any one of π/2 and π·3/2.

13. The DQPSK modulation apparatus according to claim 1, further comprising an intensity modulating unit that converts the coherent light beams into return-to-zero-pulsed light beams.

14. An optical transmitting apparatus comprising:
a DQPSK modulation apparatus that includes
a branching unit that branches light output from a light source into light beams,
a phase control unit that controls a phase of one of the light beams to π/2,
a phase modulating unit that performs phase modulation on each of the light beams,
an interfering unit that makes the light beams subjected to the phase modulation interfere with each other to obtain coherent light beams, and
a changing unit that changes a phase amount by which the phase of the one of the light beams is controlled from π/2 by an amount corresponding to a desirable penalty amount; and
a transmitting unit that transmits signal light that is modulated by the DQPSK modulation apparatus.

15. A DQPSK modulation method comprising:
branching light output from a light source into light beams;
controlling a phase of one of the light beams to π/2;
performing phase modulation on each of the light beams;
making the light beams subjected to the phase modulation interfere with each other to obtain coherent light beams; and
changing a phase amount by which the phase of the one of the light beams is controlled from π/2 by an amount corresponding to a desirable penalty amount.

16. The DQPSK modulation method according to claim 15, further comprising generating two data code strings that are constituted of alternating values or respectively identical values, wherein
the phase modulation is performed using the two code strings, and
the changing includes changing the phase amount to any one of 0 and π.
